(19) United States
(12) Patent Application Publication
(10) Pub. No.: US 2004/0115489 A1
(43) Pub. Date: Jun. 17, 2004

(54) Water and energy management system for a fuel cell

(76) Inventor: Manish Goel, Berkeley, CA (US)

Correspondence Address: Alfred D. Lobo, Esq., LOBO & CO., L.P.A., 933 The Leader Building, 526 Superior Avenue, Cleveland, OH, 44114-1401, US

(21) Appl. No.: 10/317,471

(22) Filed: Dec. 12, 2002

(51) Int. Cl. H01M 8/04

(52) U.S. Cl. 429/13; 429/26

(57) ABSTRACT

Transport of water in a fuel cell system between a first gaseous stream having a higher concentration of water and a second gaseous stream having a lower concentration of water, by mass and heat transfer, is effected through a plurality of non-hydrophilic membranes in a membrane module, such that water uptake of the selective layer is less than 10 wt % measured at a water activity of 0.9 and at a temperature of 30° C.; the membrane has a minimum pressure-normalized water flux of 100 GPU at 50° C., and maintains an ideal selectivity of water over any remaining component in the gas mixture greater than 5 at 50° C. Water and heat are transferred from an exhaust stream from either the cathode or anode compartment of a PEM fuel cell into an incoming reactant stream, whether oxidant or fuel. Operation is at a temperature above 50° C. and water activity greater than 0.5 at that temperature; a membrane having a selectivity for water over any other component in the range from 50 to 500 at an operating temperature in the range from about 100° C. to 250° C. is preferred.

### FIELD OF THE INVENTION

This invention relates to a fuel cell, also referred to as a “fuel cell stack”, operated in combination with a technically feasible and economically viable membrane based water and energy management system that improves the overall efficiency of the fuel cell system by facilitating efficient water and heat transfer between two predominantly gaseous streams in the fuel cell system providing continuous, long-tern and maintenance free operation. More particularly, the invention relates to a fuel cell system that utilizes a proton exchange membrane (“PEM”) in which an electrochemical reaction generates electrical energy, heat and water. Water and energy management is a major techno-economical challenge for PEM fuel cell systems.

### BACKGROUND OF THE INVENTION

Definitions

Gas or Gaseous: means gas and/or vapor including up to 0.1% liquids by volume.

Water uptake of a material: is defined as the equilibrium amount of water absorbed in grams by 100 grams of material at a specified temperature and a specified water activity. Water uptake is expressed as “percent by weight (wt %)” based on the dry weight of the material.

How water uptake is measured: There are several known methods for determining water uptake for a solid material. One of methods is described in “Permeation through and Sorption of Water Vapor by High Polymers”, by Paul M. Hauser and A. Douglas McLaren, Industrial and Engineering Chemistry, Vol. 40, No. 1, pages 112-117, January 1948; and in “Solubility of Water in Polyimides: Quartz Crystal Microbalance Measurements”, by Christopher R. Moylan, Margaret Evans Best, and Moonhor Ree, Journal of Polymer Science: Part B: Polymeric Physics, Vol. 29, pages 87-92, 1991, describes another method. Other methods have been described in Water in Polymers, Chapter 8, by J. A. Barrie.

Water activity: of a gaseous mixture at a given temperature is defined is the ratio (partial pressure of water)/(vapor pressure of water) at that temperature. In most instances, water activity and relative humidity are synonymous; water activity may be greater than 1 when liquid water is present in the gaseous stream.

Hydrophilic Material: A material with water uptake of at least 10 wt %, based on the dry weight of the material, measured at a water activity of at 1.0 at 30° C.

Non-Hydrophilic Material: A material with water uptake less than 10 wt %, based on the dry weight of the material, measured at a water activity of at 1.0 at 30° C.

Selective layer: is defined as the layer in the membrane structure in which substantially all or most of the separation of components occurs by capillary condensation or solution-diffusion mechanism. The selective layer as included herein is the ultramicroporous membrane or the dense membrane as defined below.

Ultramicroporous Membrane: is a selective layer comprising pores (free volume elements in the polymer chains) with average diameters in the range from about 10 Å to 100 Å. Such pores are substantially permanent within the polymer chains that make up the membrane matrix. Molecules permeate the membrane through free-volume elements between the polymer chains that are transient on the time scale of diffusion (permeation) processes occurring, predominantly by pore-flow or capillary condensation mechanism. (see Membrane Technology and Applications by Richard W. Baker, McGraw-Hill, 2000).

Dense or Non-porous Membrane: is a selective layer in which the maximum pore (free volume element in the polymer chain) diameter is about 10 Å. Molecules permeate the membrane through free-volume elements between the polymer chains that are transient on the time scale of diffusion (permeation) processes occurring, predominantly by solution diffusion or pore-flow mechanism or both. Generally, solution-diffusion is prevalent when pores (free volume elements) are less than about 5 Å, and both solution-diffusion and pore-flow are prevalent with pores in the range from about 5 to 10 Å.

Membrane: consists of at least one selective layer made from a dense membrane or an ultramicroporous membrane. If the membrane consists of only the selective layer, is it called “isotropic”. However, the membrane may be “anisotropic”. Anisotropic membrane may be integrally skinned or composite. An integrally skinned membrane is multilayer, typically a bilayer or a trilayer. Anisotropic membranes may contain one or more selective layers and may also contain one or more microporous layers in which the pores have diameters greater than 0.01 micron (100 Å). A microporous layer is usually used in anistropic membranes to provide support to a dense or ultramicroporous selective layer. Anisotropic membranes may also contain a defect repair layer, for example polydimethylsiloxane (PDMS) may be used to remove defects in asymmetric membranes formed from glassy polymers. Another type of anisotropic membrane is where an ultramicroporous membrane is coated with a dense hydrophilic material.

Pure Component Pressure-normalized Water flux: hereafter “water flux” for brevity, is the volume of water vapor in cm³ (at standard temperature and pressure “STP”) that passes through a unit area of membrane (cm²), per unit time (s) under a pressure gradient of 1 cm Hg.

How Measured: The method for measurement of water flux is described in “Part I.

Determination of the Permeability Constant” by C. E. Rogers, J. A. Meyer, V. Stannett, and M. Szwarc in Permeability of Plastic Films and Coated Papers to Gases and Vapors-TAPPI Monograph Series, No. 23, published in 1962 by the Technical Association of the Pulp and Paper Industry. The apparatus described in the method above can be made from stainless steel or other suitable materials to make measurements at higher temperatures and pressures. Far more modern instruments are used now to make more accurate determinations.

Pure Component Pressure-normalized Gas flux: hereafter “gas flux” is defined in a manner analogous to the definition of water flux.

How Measured: Methods for measurement of the gas flux are described in “Part I. Determination of the Permeability Constant” by C. E. Rogers et al., supra.

Gas Permeation Unit “GPU”:given as [10⁻⁶ cm³ (STP)/(cm².sec.cm Hg)] is a unit for measuring the pressure-normalized flux.

Ideal or Intrinsic Selectivity: “Selectivity”, for brevity, of a membrane is the ratio of pure component pressure-normalized fluxes of two components.

Effective or “Mixed-Gas” Pressure-normalized Flux: of a component in a fluid mixture is the actual pressure-normalized flux that is measured when the membrane is used in a separation process, taking into account, effect of interaction of various components in the fluid mixture with the membrane, effect of pressure, and mass transfer effects.

Effective or “Mixed-GAS” Selectivity: of a membrane is the ratio of effective pressure-normalized fluxes of two components.

Effective pressure-normalized fluxes of components are most preferably used to predict membrane performance. Effect of pressure on flux can be generally ignored for fuel cell systems operating in the range from about 1 atm to 20 atm, typically 1 to 10 atm, because high pressures above 20 atm (approx. 300 psig) are usually not encountered. However, effects of composition of the fluid mixture and mass transfer are significant in membranes made from hydrophilic materials. Such materials swell upon exposure to gaseous streams with high water activity. This has a drastic effect on fluxes of all the components in the gas mixture. Furthermore, hydrophilic materials usually have extremely high water fluxes, therefore, when they are packaged into a membrane module for use in separation, mass transfer effects are also significant.

Experimental measurement of effective fluxes is an arduous task. However, for the non-hydrophilic materials used herein the above mentioned effects are usually much less important.

Thus, it has been found that when a process model is used to simulate performance of membranes made from non-hydrophilic materials, which model assumes no mixing on each side of the membrane, one can calculate water vapor exchange between two fluid streams with reasonable accuracy using (as input) pure component fluxes.

Membrane Module: a membrane packaging device. Examples of membrane module configurations are hollow-fiber, tubular, plate and frame etc. Any suitable membrane module must allow for simultaneous entry and exit of two streams.

It is well known that a solid polymer fuel cell (PEM fuel cell) which relies upon an ion exchange membrane for its operation is adversely affected by depletion of water molecules within the membrane because the ionic conductivity is directly dependent on the water content of the proton exchange membrane. To cope with the resulting problem of inefficient operation, either a oxygen-containing oxidant stream (cathode side reactant), typically air or oxygen-enriched air, is humidified; or, the fuel stream (anode side reactant), typically a predominantly hydrogen-containing (“hydrogen-rich”) gas mixture, is humidified; or both are humidified before they are introduced into a fuel cell stack.

Water consumption and production in the fuel cell stack must be balanced to substantially eliminate the need for make-up water. Water produced in the fuel cell stack must be recovered from the stack exhaust and transferred to other streams in the fuel cell system, thus managing the water in the system. However, there must not be so much water that electrodes, which are bonded to the electrolyte, are flooded. Flooding blocks the pores in the electrodes and inhibits gas diffusion. Efficient transfer and recovery of water requires that it be effected without a phase change, that is, in a predominantly gaseous state by water and energy exchange between two predominantly gaseous streams. For efficient operation, it is critical that neither predominantly gaseous stream, suffers a pressure drop greater than 15% of its absolute pressure at entrance.

The task of humidification of a reactant stream was addressed at least as early as nearly two decades ago in UK Patent No. GB2139110B granted 20 May 1987, which disclosed that commercially available membranes of cellulose and of Nafion® perfluorinated carbon provided the desired water vapor exchange. Such membranes exhibit excellent water flux and water-gas selectivity. However, they exhibit a water uptake much greater than 10 wt % at a water activity of 1.0 at 30° C. (see Table 1 below—as reported in “Water Sorption and Transport Properties of Nafion 117H,” by David R. Morris and Xiaodong Sun, Journal of Applied Polymer Science, Vol. 50, pp 1445-1452 (1993)). Cellulosic materials such as cellophane also exhibit extremely high water uptakes and may swell to as much as twice its dry volume. The UK reference failed to recognize the criticality of high water uptake leading to dimensional instability of the membrane. Furthermore, they are silent on the allowable pressure drop that is vital to the construction of a feasible water and energy management system.

Subsequently, Japanese patent application number 04-280358 published 13 May 1994 (Publication No. 06-132038) to S. Yasutaka disclosed a gas humidification chamber which humidified oxidant gas by recovering moisture in the gas exhausted from the cathode chamber, using a vapor permeable membrane. Though Yasutaka used a vapor permeable membrane, the example provided for a suitable membrane is an ion-exchange membrane SUNSEP-W manufactured by Asahi Glass Co., Japan. Like other ion-exchange membranes like Nafion 117, Sunsep-W is also made of fluorinated ion-exchange polymer and has unacceptably high water uptake (Refer to Table 1). Yasutaka, like the GB reference, failed to address the criticality of excessive pressure drop.

Another Japanese patent application number 07-073864 published 18 Oct. 1996 (Publication No. 08-273687) to F. Futoshi et al disclosed a hollow fiber membrane bundle to humidify incoming oxidant gas with liquid water or cathode exhaust gas. They suggested fibers made from polymer resin, ceramic material or an ion-exchange polymer such as phenolic sulfonate, polystyrene sulfonate, polytrifluorostyrene sulfonate or perfluorocarbon sulfonate. Their concern was to choose a polymer with an appropriately high water vapor permeability (that is, water vapor flux), but failed to recognize that selectivity of water relative to each (or any) component in the mixture of gases in the system is a critical consideration for a feasible membrane system, not only the water vapor flux. They too like other inventors fail to other the criticality of the pressure drop issue.

U.S. Pat. No. 6,106,964 to Voss et al discloses a combined heat and humidity exchanger separated by a water permeable membrane which is preferably impermeable to the reactant, and more preferably is substantially gas-impermeable, to prevent reactant portions of the supply and exhaust streams from intermixing. As in other references, the specified membranes are made from cellophane and Nafion® perfluorosulfonic acid (see col 5, lines 47-53) each of which is known to have both very high water vapor flux and very high selectivity for making water-gas separations, but neither of which has dimensional stability under high water activity conditions and high temperatures, typically above 50° C., resulting from their high hydrophilicity and subsequently, unacceptably high water-uptake. In the '964 patent, a particularly suitable membrane has not been identified. Voss et al concede that Nafion® identified as a non-porous dense cation exchange membrane relying on the solution-diffusion model for water-gas separation, “may not be a preferred membrane material in such constructions. More dimensionally stable membranes may therefore be. (sic)” (see '964, col 12, lines 34-36). This statement of a desired result falls short of being an enabling disclosure.

More recently, A. D. Mossman discloses a membrane exchange humidifier in U.S. Publication No. 2001/0046616 A1. As in prior references, Mossman states that Nafion® may be a suitable membrane material; however, he has recognized the disadvantages of using such ion-exchange materials (paragraph 0010). He therefore uses a water permeable membrane comprising a microporous polymer having an average pore size greater than 0.025 μm and a hydrophilic additive. Examples of hydrophilic additives are inorganic materials such as alumina and silica. However, porous membranes exhibit low selectivity due to high leakage rate of gases, especially when such membranes are dry.

U.S. Publications 2001/010496, 2001/015500, 2001/0010871 A1, 2001/0010872 A1, 2001/0021467, 2002/0039674 and 2002/0041985, all by H. Shimanuki, Y. Kusano, T. Katagiri and M. Suzuki disclose humidification systems using hollow-fiber water permeable membranes. However, examples of such membranes are not provided. U.S. Publication 2001/0021468 by Kanai et al also disclose a water condensation membrane or an ion-hydration type membrane.

In view of the foregoing teachings requiring hydrophilic membranes having very high water vapor flux and selectivity, both associated with high water uptake, choosing a non-hydrophilic polymeric membrane having relatively low water uptake was counter-intuitive. Such membranes were used in the prior art to transport a component from a

stream at a much higher pressure than the stream into which that component was transferred, with little reason to be concerned with the pressure drop from stream inlet to stream outlet. In typical gas-drying operations, water is transferred from a stream at high pressure into a stream at substantially lower pressure, typically less than 10-20% of the high pressure, under pressure-driven conditions. However, such membranes fortuitously provide a minimum pressure-normalized water (pure component) flux of 100 GPU at and above 50° C. at a water-gas ideal selectivity greater than 5, and using such a membrane in a module for water management and energy in a PEM fuel cell systems allows transport of water from the humid cathode exhaust stream at a relatively low pressure into an incoming dry oxidant stream at a relatively higher pressure, each stream being subjected to a pressure drop less than 15% of its inlet pressure, if appropriately designed.

None of the prior art references enables a practical solution to the over-riding problem in any fuel cell system in which water and heat energy are to be recovered; that is, to humidify the oxidant gas and simultaneously recover the heat energy in the exhaust gas which contains water, using a stable highly water-selective membrane the performance of which does not suffer physical and chemical deterioration due to heat and moisture (referred to as “hygrothermal ageing”) despite cycling through a large number of cycles, and to do so with expenditure of a minimum amount of energy and with a minimum amount of equipment. None of the many references which discuss humidifying a relatively dry oxygen-containing gas stream through a membrane, recognized that the key to controllably and efficiently humidifying an incoming reactant gas with water from the exhaust gas, was to use a non-hydrophilic membrane having relatively lower water-gas selectivity and water uptake than presently used membranes, and which would operate with a pressure drop of less than 15% of the inlet pressure when packaged into a module, over a multiplicity of cycles until the membrane is to be replaced. The prior art choice of membranes for water and energy management in a fuel cell system was largely based on conventional gas drying operations where the conditions are very different from those encountered in a fuel cell system.

### SUMMARY OF THE INVENTION

Transport of water in a fuel cell system between a first gaseous stream having a higher concentration of water than a second gaseous stream, by mass and heat transfer, is effected through a plurality of membranes in a membrane module; such that water uptake of the membrane is less than 10 wt % measured at a water activity of 1.0 at a temperature of 30° C.; the membrane has a minimum pure component pressure-normalized water flux of 100 GPU at 50° C., and maintains an ideal selectivity of water over any remaining component in the gas mixture to be greater than 5 at 50° C., it being recognized that a membrane used in a higher temperature range will desirably have a higher selectivity; and pressure drop through each zone of the membrane module is less than 15%, preferably less than 10%, most preferably less than 5% of the absolute pressure at the entrance of the selected zone.

More specifically, a water uptake of less than 10% by weight, preferably less than 7%, and most preferably less than 5%, at a water activity of 1.0 at 30° C. based on the dry weight of the membrane, is a critical property of a non-hydrophilic membrane found to provide efficient transfer of water and heat from an exhaust stream from either the cathode or anode compartment of a PEM fuel cell into an incoming reactant stream, whether oxidant or fuel, even if the membrane has a lower water flux and water-gas selectivity than a membrane of hydrophilic ion-exchange polymer such as Nafion® or cellophane. The high water uptake, physical and dimensional instability of hydrophilic membranes, and their susceptibility to damage after less than a large number of start-up and shut-down cycles counters their high water flux and high selectivity of water over both oxygen and nitrogen. Transfer of water from fuel cell exhaust gas, which may contain hot water in liquid phase, to reactant gas requires operation at a temperature above 50° C. and high water activity, typically greater than 0.5 at that temperature, and preferably uses a membrane having a selectivity for water over any other component in the range from 10 to 1500 at an operating temperature in the range from about 50° C. to 250° C.

Though most effective in the recovery of water and energy from the cathode exhaust of a PEM fuel cell, the membrane based water and energy management system may also be used to transfer water, hydrogen and energy from the anode exhaust into a reactant stream of natural gas which is processed to generate hydrogen-rich fuel fed to the anode, as illustrated below. Sufficient detail in provided in this invention that, in a generally analogous manner, anyone skilled in the art may use the membrane in any fuel cell system where recovery of water and/or heat energy is desirable for techno-economic reasons. Examples of other fuel cell systems where this process may be applied are solid oxide fuel cell system and molten carbon fuel cell systems. The invention is also applicable in hybrid fuel cell systems. Furthermore, the invention may be used in stationary, mobile and portable fuel cell systems for both military and non-military applications. Stationary fuel cell plants may range from 3 to 10 kW for apartments and homes, to large units ranging from 10 kW to 250 kW for buildings, hotels, apartment complexes and the like. High capacity fuel cell power plants may range from about 200 kW to 10 MW capacity or higher for distributed generation. Mobile applications include motive power for vehicles and as on-board electric power source in closed environments such as in a space vehicle and submarine. The membrane system may also be used in portable applications and auxiliary power units (APU). Example of portable fuel cell devices include 1 kW units for powering LED signs on highways.

### BRIEF DESCRIPTION OF THE DRAWING

The foregoing and additional objects and advantages of the invention will best be understood by reference to the following detailed description, accompanied with schematic illustrations of preferred embodiments of the invention, in which illustrations like reference numerals refer to like elements, and in which:

FIG. 1 is a schematic illustration of a system in which a PEM fuel cell stack and a water and heat-recovery membrane module are used in combination, water from the cathode exhaust (from the cathode side of the fuel cell) being recovered in the oxidant to the cathode side.

FIG. 2 is a diagrammatic illustration of a membrane module having a bundle of hollow fibers held in a shell-and-tube configuration.

FIG. 3 is a schematic illustration of a combination in which water from the anode exhaust (from the anode side of the fuel cell) is recovered in natural gas which is then processed into hydrogen-rich fuel fed to the anode side.

### DETAILED DESCRIPTION OF PREFERRED EMBODIMENTS

Because the preferred exchange of water between two gas streams through a membrane with one at least one selective layer is governed by solution-diffusion, pore-flow and/or capillary condensation mechanism, the use of hydrophilic polymers such as Nafion, Sunsep-W and cellophane was intuitively suggested because a highly water-absorbent material would facilitate transport of water through it. When a non-hydrophilic polymer is used, it is filled with a hydrophilic material, as in US 2001/0046616A1. Non-hydrophilic polymers unfilled with a hydrophilic material are now counter-intuitively found to provide a membrane for an economical module in applications where water vapor exchange is desired to the substantial exclusion of other gaseous components in a stream.

The intuitive preference for high water-uptake polymers, as quantified below in Table I, and attendant dimensional instability, is negated by the performance of non-hydrophilic membranes which have a water-uptake of <10% by weight at a water activity of 1.0 @ 30° C. The values of the polymers are compared at three different water activities.

TABLE I

| | | | Water Activity | |
|---|---|---|---|---|
| | | | 0.5 | 0.9-1.0* |
| Membrane Material | Ref. id. | Temp. ° C. | Water Up-take | |
| Nafion ® 117 | 1 | 30 | 7.0 | 22.0 |
| Sunsep-W ® | 2 | 30 | 6.0 | 18.0 |
| Cellophane | 3 | 30 | 9.6 | 40.0 |
| Ube Membrane | 4 | 25 | 3.2 | 5.2 (0.9) |
| (Dehumidification) | | | | |
| Ube Membrane | 4 | 25 | 1.5 | 3.0 (0.9) |
| (Vapor Permeation) | | | | |
| PDMS | 5 | 35 | 0.015 | 0.07 (0.95) |

*A method for accurate control of water content and subsequently control and measurement of water activity in the range >0.9 is not available.

### REFERENCES

1. Thomas A. Zawodzinski, Thomas E. Springer, John Davey, Roger Jestel, Cruz Lopez, Judith Valerio and Shimshon Gottesfeld, “A Comparative Study of Water Uptake by and transport through ionomeric fuel cell membranes,” Journal of Electrochem. Soc., Vol. 140, No.7, pp. 1981-1985 (July 1993).

2. Junjiro Iwamoto, “Water Vapor Permeable Membrane-Function & Applications,” Journal of Kagaku Sochi, Special Issue-Membrane Separation Technology for Year 2000, pp. 80-84 (September 2000).

3. J. A. Barrie, “Water in Polymers,” Table I in Chapter 8 in Diffusion in Polymers, pp. 259-313, edited by J. Crank and G. S. Park, published by Academic Press Inc. (1968).

4. K. Okamoto, N. Tanihara, H. Watanabe, K. Tanaka, H. Kita, A. Nakamura, Y. Kusuki and K. Nakagawa, J. Polym. Sci., Part B: Polym. Phys. Ed., Vol. 30, pp 1223-1231 (1992).

5. J. A. Barrie, “Water in Polymers,” Table II in Chapter 8 in Diffusion in Polymers, pp. 259-313, edited by J. Crank and G. S. Park, published by Academic Press Inc. (1968).

Further, though prior art hydrophilic polymers provided excellent water flux and selectivity for water over any unwanted component, the membranes were dimensionally unstable. The non-hydrophilic membranes with at least one dense or ultramicroporous selective layer used herein allow continuous operation at a temperature in the range 50-175° C. and are dimensionally stable after continuous long-term operation including a multiplicity of start-up and shut-down cycles. Such selective layers may be made from glassy or rubbery polymers provided the membrane formed have a water-uptake less than 10% by weight at a water activity of 1.0 at 30° C.; an ideal selectivity of water over any other component preferably in the range 20 to 1000; and, the membrane is used in a module in which a pressure drop through each, the wet and dry zones on either side of the membrane is less than 15% of the absolute pressure at the entrance of the zone.

Typically, the water flux is at least 1×10⁻⁴ cm³/cm².sec.cm Hg (100 GPU) for practical water recovery; preferably it is in the range from 100 to 25,000 GPU, most preferably in the range from about 500 to 15000 GPU.

Preferred non-hydrophilic membranes which meet the foregoing essential criteria must contain at least one dense or ultramicroporous selective layer; membrane may be isotropic or anisotropic (asymmetric); furthermore, the asymmetric membrane may be integrally skinned or composite, or any combination of the foregoing. A preferred selective layer is made from a glassy or rubbery polymer operable in the range from about 50° C. to about 250° C. in the fuel cell. Most preferred are glassy polymers having a glass transition temperature Tg>90° C., preferably in the range from 90° C. to 350° C. and most preferably in the range from 150° C. to 350° C. The term “iglassy” is used herein to denote that the membranes are used in their glassy state, below their softening or glass transition temperature “Tg” which is in the range from about 90° C. to 350° C.

Glassy polymers that may be used to form the dense or ultramicroporous selective layer include but are not limited to polycarbonates, polyetherimides, polysulfones, polyethersulfones, polyimides, polyamides, polyamideimides, poly (phenylene oxides), polyacetylenes such as poly(1-trimethylsilyl-1-propyne) or PTMSP, and the like. More preferably, aromatic polycarbonates, aromatic polyetherimides, aromatic polyimides, aromatic polyamides (polyaramids) and aromatic polyamideimides may be used.

Rubbery polymers may be used to form the selective layer. The term “rubbery” is used herein to denote that the membranes are used in the rubbery state, i.e. above the softening or glass transition temperature “Tg”. Useable rubbery polymers for this invention must have a service temperature for continuous use greater than 50° C., more preferably greater than 100° C. and most preferably greater than 150° C. Rubbery polymers include but are not limited to natural and synthetic polyisoprene, nitrile rubber, polybutadiene, polystyrene-butadiene copolymers, polyisobutylene-isoprene copolymers, polyethylene-propylene copolymers, polychloroprene, chlorosulfonated polyethylene, thermoplastic elastomers, polyurethanes, fluorocarbons, fluorosilicones, siloxane polymers such as silicone rubber (polydimethylsiloxane or PDMS).

Useful polymers may be blended, used as homopolymers or co-polymers, modified by changes in physical structure (changing degree of crystallinity), or in chemical structure (by substitution of chemical groups), modified by addition of cross-linking agents, plasticizers etc. to improve their properties. Hydrophilic materials such as ion-exchange, cellulosic polymers and polyamides may be used only after their structure is modified by altering cross-linking density, polarity etc. to a level such that the resulting membrane has a water-uptake less than 10 wt % at activity of 1.0 @ 30° C.

The membranes used may be prepared by a variety of methods. The methods for preparation of isotropic and anisotropic membranes are well known in the art of manufacture of membranes. Chapter 3 titled “Membranes & Modules” in the book “Membrane Technology and Applications” by Richard W. Baker, supra, is one of the many references for membrane production methods.

When anisotropic membranes are used, a support layer may be the mechanical support for the selective layer. An appropriate support layer, whether organic or inorganic, is highly permeable to minimize resistance to permeation, and thermally and chemically resistant to streams it is exposed to.

For construction of a high performance membrane-based water and energy management system, it is most preferred to use anisotropic membranes in which the selective layer is made from a glassy polymer, as in glassy aromatic polyimides used herein.

Most preferred for making a concentration-driven separation of water vapor from permanent gases such as oxygen, nitrogen, carbon dioxide and carbon monoxide etc. is an aromatic polyimide hollow fiber or flat sheet membrane used in the prior art to separate water vapor from methane; the membrane has a water vapor permeating (transmission) rate, or “water vapor flux” of more than 100 GPU (1×10⁻⁴ cm³/cm².sec.cm Hg), preferably in the range from 500 to 15,000 GPU (5×10⁻to 1.5×10⁻² cm³/cm².sec.cm Hg, at 50° C.). Aromatic polyimides are most preferred, but the choice depends upon the conditions under which the membrane is to be used, and the techno-economic performance demanded of the membrane module.

The polyimide membrane is prepared by the reaction of an aromatic tetracarboxylic acid with an aromatic diamine component to yield the polyimide which may be reacted with water to yield the polyamic acid. A solution of either the polyimide or polyamic acid in an appropriate solvent may then be used to produce a precursor article, whether by casting into sheets or extruded through a nozzle to form hollow fibers, and evaporating the solvent from the cast or extruded articles to form a solidified precursor.

The solidification of the precursor may be effected by a coagulating method in which the precursor is immersed in a coagulating liquid. This coagulating method causes the resultant coagulated membrane to have an asymmetric structure in which a non-porous dense upper layer is formed upon, and in contact with, a microporous lower layer. The non-porous dense layer portion (skin) preferably has a thickness in the range greater than 0.01 μm, preferably greater than 0.02 μm, in the range from 0.02 to 0.2 μm. The microporous lower layer has a thickness in the range greater than 20 μm, preferably greater than 30 μm, in the range from 30 to 300 μm. The preferred overall thickness of the membrane is in the range from 20 μm to 300 μm. If desired, the hollow fiber membrane prepared in the above process may subsequently be subjected to an additional treatment which comprises the steps of: essentially completely replacing residual coagulation liquid in the membrane with a substitute-solvent e.g. an aliphatic hydrocarbon such as iso-pentane, n-hexane, iso-octane and n-heptane, to swell the membrane and drying the swollen membrane by evaporation to yield a dry asymmetric hollow fiber membrane. Preferably, the dry asymmetric hollow fiber is then heat-treated at a temperature below the softening point or the second order transition point of the aromatic polyimide, typically in the range from about 90° C. to 400° C.

A preferred hollow fiber has an outer diameter in the range from about 50 μm to 300 μm, more preferably in the range from 300 μm to 2,000 μm; a preferred inner diameter is in the range from about 100 μm to 1,500 μm, more preferably in the range from 200 μm to 1,000 μm; the inner diameter being chosen to provide less than the allowable pressure drop through lumens of fibers in a single module, preferably less than 15% of the pressure at the entrance, more preferably less than 10%, most preferably less than 5% of the pressure at the entrance. Typically the ratio of thickness to outer diameter of a fiber is in the range from 0.1 to 0.3 so that the membranes function as both, efficient heat transfer and also mass transfer elements.

The gas separating membrane is produced by evaporating the solvent from the precursor at an elevated temperature or under a reduced pressure. If produced in the shape of flat film, the range of its thickness corresponds to that of a hollow fiber, as do the characteristics of the film's dense and porous layers.

Alternatively, the gas separating membrane can be produced by coating a substrate consisting of a porous material with a solution of the aromatic polyamic acid or the aromatic imide polymer to form a thin layer of the solution and by solidifying the thin layer of the solution to form a composite membrane consisting of a porous substrate and a dense coating layer of the polymer.

In the preparation of the aromatic imide polymer, the aromatic diamine component preferably contains 20 to 100 mol %, more preferably 40 to 100 mol %, of at least one aromatic diamine compound having at least one divalent radical selected from the group consisting of —S—and —SO₂— radicals, and the aromatic tetracarboxylic acid component preferably contains 50 to 100 mol %, more preferably 80 to 100 mol %, of at least one member selected from the group consisting of biphenyl tetracarboxylic acids, benzophenone tetracarboxylic acids, pyromellitic acid, preferably biphenyl tetracarboxylic acids, and dianhydrides, and esters of the above-mentioned acids. The above-mentioned specific aromatic tetracarboxylic acid component and diamine components are usually polymerized in equimolar amounts.

In greater detail, the gas separating membrane is prepared from a “dope” of a solution of the polyimide of the corresponding precursor polyamic acid dissolved in an organic solvent which provides the solution with a viscosity suitable for shaping the solution into a hollow filament or a flat sheet, after which the solvent is evaporated. Alternatively, the shaped dope solution is led through a coagulating liquid to remove the solvent. When a dope of the polyamic acid is used it is imidized to the corresponding polyimide.

For example, the aromatic tetracarboxylic acid component and the aromatic diamine component in equimolar amounts are subjected to a one step polymerization-imidization process in a phenolic solvent at about temperature of about 140° C. The resultant polyimide solution from the polymerization-imidization process is used as a dope solution which usually contains 3 to 30% by weight of the polyimide. This solution is extruded to form hollow fibers, or, is sheeted on a planar surface to form a thin layer of the dope solution at a temperature in the range from 30° C. to 150° C. The hollow fibers or thin layer of dope is coagulated in water and ethyl alcohol. The coagulated hollow filaments or thin layer are dried to remove residues of the solvent and the coagulating liquid by evaporation, and then heated in the range from about 150° C. to 400° C., preferably 170° C. to 350° C. The resultant membrane is asymmetric, that is, it has a non-porous dense layer portion and a porous layer portion. Further details of these polyimide membranes are provided in U.S. Pat. No. 4,718,921 to Makino et al, and other polyimide membranes are disclosed in U.S. Pat. Nos. 4,370,290; 4,378,324; 4,440,643; 4,460,526; 4,485,056; 4,978,430; 5,286,539 and 5,744,575 the disclosures of which are incorporated by reference thereto as if fully set forth herein.

The hollow-fiber membranes may be packaged into a hollow-fiber membrane module. The tubes may be packaged into a tubular membrane module and the flat-sheets may be packaged into a plate-and frame module (plate and frame module construction is described in detail in Voss patent). The construction of the membrane modules should be such that, during operation, pressure drop of either stream does not exceed 15%, more preferably does not exceed 10% and most preferably does not exceed 5% of its absolute pressure at the inlet. Two or more membrane modules may be arranged in an array connected in series/and or parallel to meet desired specifications. Connecting membrane modules in parallel is the preferred embodiment to minimize the pressure drop.

The housing of a membrane module is constructed of a material that is resistant to pressure, and thermally and chemically stable to streams it will encounter. This material contributes to the weight of the device. Therefore, it is preferable to construct the membrane module from a light-weight material, for example, polysulfone, PVC, PVDF, CPVC, nylon and polycarbonate. The hollow fibers are potted into headers or tube-sheets and sealed as required, appropriate materials being chose to meet mechanical, thermal and chemical tolerance requirements.

It is essential that a hollow-fiber membrane module be dimensioned and the fiber packing density be such as to minimize the pressure drop of both streams flowing into the membrane module so that the pressure drop requirement of <15% can be met. In a conventional gas-drying process, pressure drop is not as critical because the actual flow rates of the streams are low due to their generally higher absolute pressures. However, in fuel cell systems, the streams are at lower pressures and as a result the actual flow rates are high, therefore, use of membrane modules with construction that is used for conventional applications is not desirable. In a fuel cell system, pressure drop is even more critical because it is a power generating device, and high pressure drops translate into high parasitic power consumption and reduced output power. This is a critical consideration because the membrane surface area typically required is in the range from 0.01 to 500 m² in a single module, whether hollow fiber, plate-and-frame or tubular; the volume of the module is optimally minimized, and maintaining the pressure drop of the stream below the allowable is a challenge.

To minimize the pressure drop on the lumen or bore side, the total length of the fibers, L, is limited and therefore, the diameter of the fiber bundle, φ, must be increased to manufacture a membrane module with a large membrane area. The ratio of the total length of the fiber and the diameter of the fiber bundle, Ω=L/φ must be minimized. This ratio should be preferably less than 10, more preferably less than 5 and most preferably less than 2. To minimize the pressure drop on the shell side, the packing density of the fiber bundle is optimized, typically being in the range of 20 to 80% of the area of the header. Usually, packing density in the range from about 35% to 75% is optimal to minimize the volume of the membrane module. There are at least two inlet ports for entrance and at least two ports for exit. The ports are sized and located such the pressure drop at the entrance and exit are minimized. Their location is optimized to maximize the effectiveness of the membrane area by minimizing by-passing.

The stream with higher water concentration may be introduced inside the hollow-fibers (bore side of the hollow fiber membrane module). It may also be introduced on the outside of the hollow fiber (shell side of the hollow fiber membrane module). The two streams may be introduced into a membrane module either counter-currently or co-currently, former being preferred.

A fiber bundle may be non-removably disposed within a shell requiring the entire membrane module be replaced upon membrane failure. Alternatively, the fiber bundle may be a replaceable cartridge disposed inside a membrane module housing as described in U.S. Pat. No. 6,210,464.

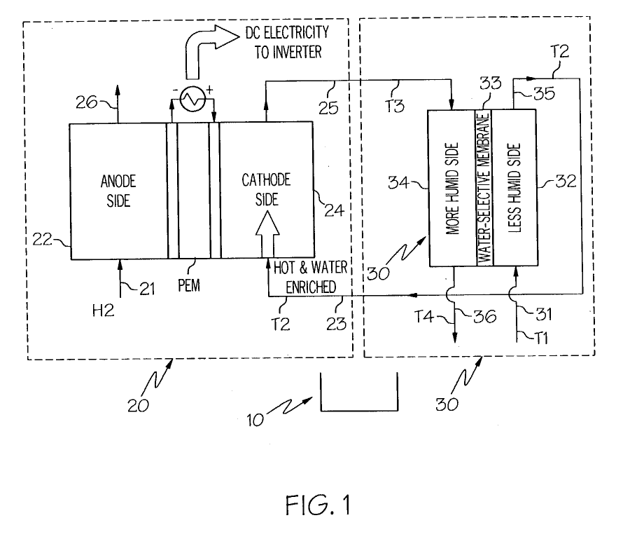

Referring to FIG. 1, there is schematically illustrated a water and energy management system referred to generally by reference numeral 10, comprising a conventional solid polymer fuel cell stack 20 and a water and energy recovery device illustrated as membrane module 30 which may be a hollow fiber module, tubular module or a plate-and-frame module. The fuel cell is conventionally operated with a fuel such as hot hydrogen rich gas 21 fed to the anode side 22 of a PEM 27 and an oxidant such as hot, water saturated air 23 at a temperature T2 flowed to the cathode side 24. Hydrogen in the fuel stream and oxygen in the oxidant stream react electrochemically and generate electricity that is led to an inverter (not shown). In addition to electricity, heat and water are produced in the PEM fuel cell. Hydrogen-depleted stream 26 is discharged from the anode side 22.

Since oxygen in air stream 23 is used up in the fuel cell, the exhaust 25 from the cathode side 24 is oxygen-depleted. Oxygen-depleted cathode side effluent 25 at temperature T3, typically saturated with water some of which may be in the liquid state (a water removal device may be used to separate liquid water—not shown), is introduced into the more humid side 34 of the membrane 33 in the module 30 so that the pressure P1 in the less humid side 32 is higher than the pressure P2 on the more humid side 34 from which water vapor at a lower pressure is to be transferred. Water in stream 25 introduced to the more humid side 34 is concentration-driven through the membrane 33 into the less humid side 32 so that effluent 35 from the less humid side 32 is at a temperature T2 and higher humidity than the incoming oxidant 31. The oxygen-depleted stream 36 flowing out of the more humid side is also depleted of water vapor and the temperature is lowered to T4, the stream 25 having given up much of its water and heat to incoming oxidant 31.

Oxidant 23 is humidified and heated to temperature T2 in membrane module 30 functioning as a combination of water transfer device and heat exchanger.

Relatively dry air 31 at temperature T1 is flowed to a less-humid first side 32 of the membrane and the hot and saturated cathode exhaust gas 25 at temperature T3 is flowed to the more humid second side of the membrane 33 in module 30 preferably in the form of flat films in a plate-and-frame type configuration, or in the form of relatively large 3 mm to 15 mm diameter tubes, or, a multiplicity of hollow fiber membranes less than 3 mm in diameter, potted near their opposed ends in spaced apart headers.

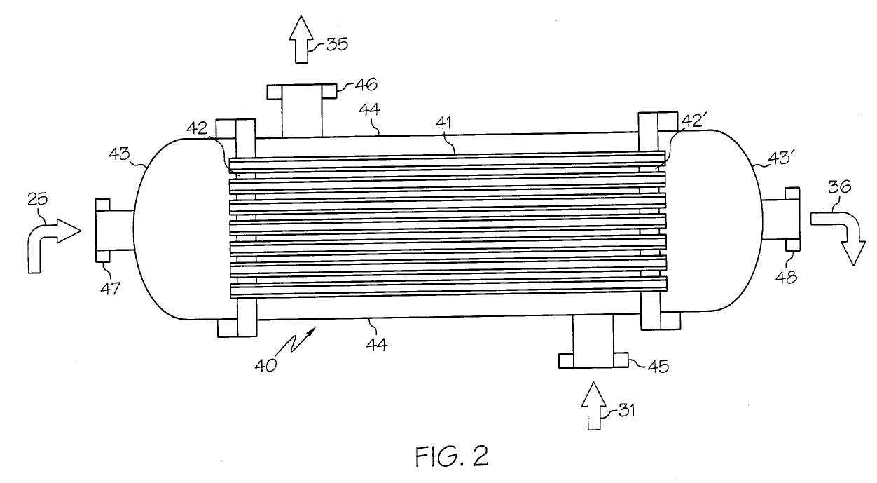

This basic configuration of the PEM fuel cell and membrane module may be adapted for use with any desired configuration of fuel cells, e.g. in combination with a fuel cell stack as described in U.S. Pat. No. 6,106,964, which description is incorporated by reference thereto as if fully set forth herein. Most preferred is one illustrated in FIG. 2 herein; a membrane module 40 is constructed in a manner analogous to a shell-and-tube heat exchanger wherein a multiplicity of fibers 41 are potted in opposed headers 42, 42′ in which each hollow fiber is sealed in fluid tight relationship so that cathode exhaust gas 25 at temperature T3 and pressure P3 from the fuel cell enters through nozzle 47 into cap 43 which is tightly sealed against header 42 and flows only through lumens of the fibers 41. Dry air stream 31 at temperature T1 and pressure P1 enters the membrane module through nozzle 45.

Water and heat transfer from the exhaust gas into the dry gas through the fibers 41.

The water-depleted exhaust gas exits at a temperature T4 and pressure P4 through nozzle 48 as stream 36 from the cap 43′. The pressure drop through the lumens is preferably less than 5%, and that through the shell side is also preferably less than 5%. The humidified and heated air stream 35 (same as stream 23) leaves through nozzle 46. Stream 35 may be treated further such as additionally humidified or heated etc. before it is introduced into the cathode side of the PEM fuel cell stack as stream 23. Furthermore, the liquid water in the exhaust gas may be removed by using a liquid-water removal device (for example, a coalescer) before it is directed to the membrane module. Other equipment such as heat exchangers etc. may be required for integrating the membrane system with the fuel cell stack.

Using the foregoing method for concurrently humidifying and heating a reactant stream to a PEM fuel cell by mass and heat transfer from an exhaust stream from the fuel cell, the improvement comprises, flowing the exhaust stream through a relatively low-pressure zone in a first side of a membrane module wherein the exhaust stream is substantially saturated, flowing reactant stream through a relatively higher-pressure zone in a second side of the membrane module, the first side and second side being separated by the membrane, and transferring water vapor from the relatively low-pressure zone to the relatively higher-pressure zone, the water vapor at a permeation rate (flux) of 5×10⁻⁴ cm³/cm².sec.cin Hg (500 GPU), while maintaining a ratio of water flux/gas flux or ideal water/gas selectivity of each component of at least 20 at operating temperature in the range from about 50° C. to 175° C. Most preferably this is effected with an asymmetric aromatic polyimide membrane having a wall defined by a non-porous dense layer and a microporous layer, and having a glass transition temperature Tg in the range from about 90° C. to 350° C.

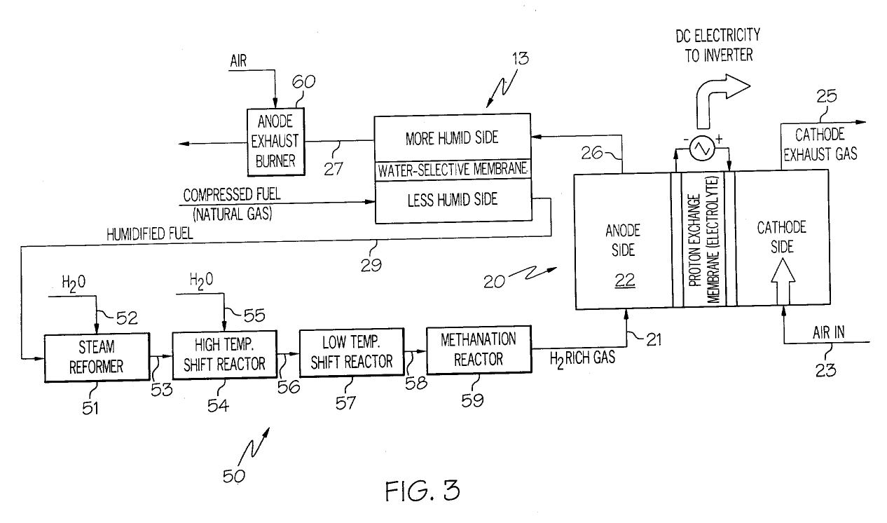

Referring to FIG. 3 there is schematically illustrated a preferred flowsheet for a fuel cell system 50, such as may be used in an automobile, in which PEM fuel cell stack 30 is operated in combination with a membrane module 13 to recover water and hydrogen. Fuel, such as natural gas in stream 28 is compressed in a compressor, cooled in an intercooler (not shown), and led into the less humid zone of membrane module 13. The exhaust gas 26 from the anode side of the fuel cell stack is led into the more humid zone of the membrane module 13. Most of the water and some of the hydrogen in the exhaust gas stream 26 is transported through the membranes that results in water and hydrogen recovery. The module 13 is designed and sized so that the stream 27 exiting the more humid side of the membrane module, and gas exiting in stream 29 from the less humid side of the module, suffer minimal pressure drop. Stream 29 enters a steam reformer 51 where the natural gas stream is reformed with water from stream 52. Stream 53 exiting the steam reformer 51 then enters a high temperature shift reactor 54 in which the CO concentration of reformed gas stream is reduced by shift reaction with water from stream 55. The stream 56 exiting the high temperature shift reactor 54 then enters a low temperature shift reactor 57 to further reduce the CO content before stream 58 enters either a methanation reactor, or a preferential oxidation reactor 59 to minimize the concentration of CO in the stream. The emerging purified hydrogen-rich stream 21 is then led into the anode side of the PEM fuel cell stack at a suitable temperature. Stream 27, depleted of water and hydrogen leaves module 13 and may be led into a burner 60 for energy recovery.

A mathematical model was developed to simulate the performance of the membrane module for water vapor and heat transfer between two gaseous streams. This particular model for the purpose of creating illustrative examples was developed for the most preferred embodiment, the two streams flowing counter-currently to each other in a hollow-fiber or tubular membrane module device. The model was incorporated into ChemCAD, a commercially available process simulator package from Chemstations, Houston, Tex.

The following assumptions were made in the calculations:

(i) Pure-component fluxes of all components are used.

(ii) Water vapor flux is assumed to be independent of temperature.

(iii) Concentration polarization has been ignored on both sides of the membrane. This effectively means that the resistance to mass transfer across the membrane lies in the membrane only.

(iv) Both streams are assumed to be entirely in the gaseous or vapor phase at inlet and therefore, free of liquids.

(v) For enthalpy (energy) balance, work of separation and Joule-Thompson effects have been ignored. Since, both the streams were assumed to gas/vapor phase only at inlet, any contribution to enthalpy due to presence of liquids was ignored. It has been assumed that heat transfer is due to thermal contact between the two streams only.

(vi) The pressure drop of both streams due to entrance and exit losses was accounted for by using empirically determined factors.

(vii) The membrane module is insulated to minimize heat loss to the surroundings, thus heat loss is assumed to be zero.

### EXAMPLE 1

The following example illustrates water recovery from cathode exhaust of a water-cooled PEM fuel cell of 7 kW electrical output power capacity operating at 70° C. and near ambient pressure, using a hollow fiber membrane module constructed from an aromatic polyimide glassy polymeric hollow fiber membrane (commercially available as Dehumidification Polyimide Membrane from Ube Industries Ltd., Japan). Such a fuel cell is suitable for residential applications.

The hollow fiber membrane module is used for water exchange from a hot and saturated cathode exhaust gas (Stream 25) to a cooler and drier cathode inlet gas (Stream 31) at a pressure of 111.6 kPa.abs.(16.2 psia or 1.5 psig). The module recovers water without phase change eliminating the need for water recovery by condensation of water in the cathode exhaust gas. In addition to water recovery, the module also functions as a heat exchanger and heats reactant air at 25° C. to near-operating temperature of the fuel cell.

The following assumptions are made:

(i) Proton Exchange Membrane (PEM)is impervious to O₂, N₂ and other gases.

(ii) The pressure drop through the cathode side of the fuel cell ≈5.17 kPa (0.75 psi).

(iii) Cathode exhaust gas is saturated.

(iv) Trace components in air are neglected (air composition is 23.22 wt % O₂+76.78 wt % N₂).

(v) Mean voltage of each cell in fuel cell stack, Vc=0.65 volts

(vi) Air stoichiometry ratio, λ=3

A membrane module designated M1 is constructed with the following specifications:

Membrane type: Asymmetric hollow-fiber membrane (dense skin on microporous support)

Water uptake: 3.2 wt % at 25° C. at water activity of 0.5; 5.2 wt % at 25° C. at a water activity of 0.9.

| | |
|---|---|
| H₂O flux at 70° C.: | 1500 GPU (based on OD of fiber) |
| O₂ flux at 70° C.: | 15.6 GPU (based on OD of fiber) |
| N₂ flux at 70° C.: | 2.7 GPU (based on OD of fiber) |
| H₂O/O₂ selectivity: | 96 |
| H₂O/N₂ selectivity: | 556 |
| Hollow fiber inside diam.: | 350 μm (microns) |
| Hollow fiber outside diam.: | 490 μm |
| Number of Fibers in module: | 75,000 |
| Total Fiber Length*, “L”: | 210 mm |
| Active Fiber Length^{▪}: | 107 mm |
| Active membrane area: | 12.35 m² (based on OD of fiber) |
| Fiber Bundle diameter, “Φ”: | 190 mm |
| Ratio (L/Φ) = Ω | 1.105 |
| Shell inside diam.: | 200 mm |
| Packing Density of fibers: | 0.4987 (49.87% of the area of the |
| | header) |
| Membrane Module Overall | 247 mm × 240 mm |
| Dimensions: | (Dia. × Length) |
| Membrane Module Housing Material: | Polysulfone |
| Streams Inlet and Exit Port | 40 mm |
| Dimensions: | |

*length includes ends of a fiber potted in opposed headers
^{▪}length of fiber between opposed faces of headers

The conditions of the gaseous streams entering and exiting the aforespecified module are presented in Table II below. The more humid “stream 1” is introduced into the lumens (bores) of the fibers, and the less humid “stream 2” is introduced in the shell side so as to flow around and in contact with the outside surfaces of the fibers.

TABLE II

| | Conditions of Streams 25, 31, 36 & 35. | | | |
|---|---|---|---|---|
| | Str'm 25 | Str'm 31 | Str'm 36 | Str'm 35 |
| | Inlet | Inlet | Outlet | Outlet |
| Temperature, ° C. | 70.0 | 25.0 | 55.1 | 68.4 |
| Pressure kPa.abs. | 106.9 | 111.7 | 104.4 | 110.94 |
| (psia) | (15.5) | (16.2) | (15.14) | (16.10) |
| Water Activity: | 1.00 | 0.75 | >1.00 | 0.69 |
| Vapor mole fraction | 1.00 | 1.00 | 0.98 | 1.00 |
| Total molar flow | 1.89 | 1.47 | 1.61 | 1.75 |
| (k mol/hr) | | | | |
| Total mass flow (kg/hr) | 48.25 | 42.08 | 43.19 | 47.14 |
| Total volumetric* flow | 50.39 | 32.61 | 41.29 | 44.82 |
| (act. m³/hr) | | | | |
| Total volumetric^{▪} flow | 42.38 | 32.95 | 36.04 | 39.29 |
| (std. m³/hr) | | | | |
| Mass % of H₂O | 20.63 | 1.35 | 11.16 | 12.10 |
| Mass % of O₂ | 13.31 | 22.98 | 15.02 | 20.38 |
| Mass % of N₂ | 66.05 | 75.67 | 73.82 | 67.52 |
| Mole % of H₂O | 29.22 | 2.14 | 16.63 | 18.06 |
| Mole % of O₂ | 10.62 | 20.55 | 12.60 | 17.12 |
| Mole % of N₂ | 60.16 | 77.31 | 70.77 | 64.82 |

*actual flow
^{▪}flow at standard temperature and pressure conditions

The performance of the membrane and M1 were characterized by the results in following Table III, obtained by computing the following considerations which are critical in the fabrication of a practical and economical water management system, namely: (a) the amount of water transferred, or water recovered (%); (b) leakage of unwanted components (O₂ and N₂ in this example); and (c) pressure drop of a wet or humid first stream on one side of the membrane (in the lumens in this example), and pressure drop of a second stream on the other side of the membrane (the shell side in this example). Other considerations in determining the overall efficiency of the device include overall dimensions and weight of the module, and the percent of available heat exchanged.

TABLE III
Results

| | |
|---|---|
| H₂O Recovery (%) | 51.6 |
| O₂ Leakage (%) | −0.64 |
| N₂ Leakage (%) | −0.03 |
| Stream 25 ΔP, kPa (psi) | 2.48 (0.36) |
| Stream 25 ΔP, % of inlet | 2.31 |
| Stream 31 ΔP, kPa (psi) | 0.76 (0.11) |
| Stream 31 ΔP, % of inlet | 0.68 |

The above data provide evidence that fibers having a nominal diameter <1 mm (1000 μm) are suitable for this application in a properly constructed membrane module.

### EXAMPLE 2

In a manner analogous to that described in Example 1 above, a module designated M2 is constructed with hollow fiber membrane of a different material, namely polydimethylsiloxane (PDMS) commercially available as NagaSep® membrane from Nagayanagi Industries, Japan. This rubbery polymer has lower water uptake than the polyimide (above). Also, the membrane made from this polymer has lower water flux and water-gas selectivities. The module was used to recover water from the same 7 KW PEM fuel cell under identical conditions as in the previous example.

Specifications for construction of M2:

Membrane type: Isotropic dense hollow-fiber membrane

Water uptake: 0.015 wt % at 35° C. at water activity of 0.5; 0.07 wt % at 35° C. at a water activity of 0.95.

| | |
|---|---|
| H₂O flux at 70° C.: | 636 GPU (based on nom. dia of fiber) |
| O₂ flux at 70° C.: | 17.1 GPU (based on |
| | nom. dia of fiber) |
| N₂ flux at 70° C.: | 9.6 GPU (based on nom. dia of fiber) |
| H₂O/O₂ selectivity: | 37 |
| H₂O/N₂ selectivity: | 66 |
| Hollow fiber inside diam.: | 400 μm |
| Hollow fiber outside diam.: | 500 μm |
| Number of Fibers in module: | 88,000 |
| Total Fiber Length*, “L”: | 500 mm |
| Active Fiber Length^{▪}: | 400 mm |
| Active membrane area: | 49.76 m² (based on |
| | nom. diam. of fiber) |
| Fiber Bundle OD, “Φ”: | 190 mm |
| Ratio (L/Φ) = Ω | 2.63 |
| Shell inside diam.: | 200 mm |
| Packing Density of fibers: | 0.39 (39.00% of the |
| | area of the header) |
| Membrane Module Overall | 247 mm × 500 mm (Dia. × Length) |
| Dimensions: | |
| Membrane Module Housing | Polysulfone |
| Material: | |
| Streams Inlet and Exit Port | 40 mm |
| Dimensions: | |

*length includes ends of a fiber potted in opposed headers
^{▪}length of fiber between opposed faces of headers

The conditions of the gaseous streams entering and exiting the aforespecified M2 are presented in Table IV below. The more humid “stream 25” and the less humid “stream 31” are each introduced into the lumens and in the shell respectively, as before.

TABLE IV

| | Conditions of Streams 25, 31, 36 & 35 | | | |
|---|---|---|---|---|
| | Str'm 25 | Str'm 31 | Str'm 36 | Str'm 35 |
| | Inlet | Inlet | Outlet | Outlet |
| Temperature, ° C. | 70.0 | 25.0 | 49.8 | 69.98 |
| Pressure kPa.abs. | 106.9 | 111.7 | 105.7 | 110.64 |
| (psia) | (15.5) | (16.2) | (15.34) | (15.88) |
| Water Activity: | 1.00 | 0.75 | >1.00 | 0.75 |
| Vapor mole fraction | 1.00 | 1.00 | 0.98 | 1.00 |
| Total molar flow | 1.89 | 1.47 | 1.55 | 1.81 |
| (k mol/hr) | | | | |
| Total mass flow (kg/hr) | 48.25 | 42.08 | 42.27 | 48.05 |
| Total volumetric* flow | 50.39 | 32.61 | 38.76 | 46.62 |
| (act. m³/hr) | | | | |
| Total volumetric^{▪} flow | 42.38 | 32.95 | 34.76 | 40.57 |
| (std. m³/hr) | | | | |
| Mass % of H₂O | 20.63 | 1.34 | 8.57 | 14.35 |
| Mass % of O₂ | 13.31 | 22.98 | 15.79 | 19.60 |
| Mass % of N₂ | 66.05 | 75.68 | 75.64 | 66.05 |
| Mole % of H₂O | 29.22 | 2.14 | 12.96 | 21.15 |
| Mole % of O₂ | 10.62 | 20.55 | 13.44 | 16.26 |
| Mole % of N₂ | 60.16 | 77.31 | 73.60 | 62.59 |

*actual flow
^{▪}flow at standard temperature and pressure conditions

TABLE V
Results

| | |
|---|---|
| H₂O Recovery (%) | 63.61 |
| O₂ Leakage (%) | −2.57 |
| N₂ Leakage (%) | −0.33 |
| Stream 25 ΔP, kPa (psi) | 1.16 (0.17 psi) |
| Stream 25 ΔP, % of inlet | 1.09 |
| Stream 31 ΔP, kPa (psi) | 1.06 (0.15 psi) |
| Stream 31 ΔP, % of inlet | 0.95 |

The evidence is that the values for the PDMS membrane provides acceptably high water recovery but requires larger membrane area and therefore, operation must accept the higher leakage than expected with the polyimide membrane.

### EXAMPLE 3

The following example illustrates water recovery from cathode exhaust of a water-cooled PEM fuel cell of 75 kW electrical output power capacity operating at 80° C., using a pair of identical modules designated M3A and M3B constructed with an aromatic polyimide glassy polymeric hollow fiber membrane commercially available as Vapor Permeation Polyimide Membrane from Ube Industries Ltd., Japan. The modules are connected for operation in parallel and streams 25 and 31 are split equally between the modules to minimize pressure drop through each. Compressed air at 308 kPa.abs.(30 psig) is used as the oxidant. It is cooled in an intercooler to 120° C. before it enters the membrane modules for water recovery.

M3A and M3B are used for water exchange from a hot and saturated cathode exhaust gas (Stream 25) to a cooler and drier cathode inlet gas (Stream 31) at a pressure of 308 kPa.abs. As before, the modules recover water without phase change and the modules also function as a heat exchangers to cool reactant air entering at 120° C. to near-operating temperature of the fuel cell. Additional humidification and/or cooling of the reactant air stream may be required before it is directed to the cathode inlet.

The same assumptions made in Examples 1 and 2 above are made herein, except that: (i) the pressure drop through the cathode side of the fuel cell ≈25.5 kPa (3.7 psi); (ii) pressure drop through the intercooler and related equipment from compressor discharge to inlet of the fuel cell is zero; and, (iii) the air stoichiometry ratio, λ=2

Each module M3A and M3B is constructed with the following specifications: Membrane type: Asymmetric hollow-fiber membrane (dense skin on microporous support) Water uptake: 1.5 wt % at 25° C. at a water activity of 0.5; 3.0 wt % at 25° C. at water activity of 0.9.

| | |
|---|---|
| H₂O flux at 80° C. & 120° C.: | 1200 GPU (based on OD of fiber) |
| O₂ flux at 80° C. & 120° C.: | 1.9 & 4.2 GPU resply. |
| | (based on OD of fiber) |
| N₂ flux at 80° C. & 120° C.: | 0.45 & 1.1 GPU resply. |
| | (based on OD of fiber) |
| H₂O/O₂ selectivity | 625 and 289 resply. |
| @ 80° C. & 120° C.: | |
| H₂O/N₂ selectivity | 2679 and 1072 resply. |
| @ 80° C. & 120° C.: | |
| Hollow fiber inside diam.: | 300 μm |
| Hollow fiber outside diam.: | 500 μm |
| Number of Fibers in module: | 75,000 |
| Total Fiber Length*, “L”: | 320 mm |
| Active Fiber Length^{▪}: | 214 mm |
| Active membrane area: | 25.25 m² (based on OD of fiber) |
| Fiber Bundle OD, “Φ”: | 190 mm |
| Ratio (L/Φ) = Ω | 1.68 |
| Shell inside diam.: | 200 mm |
| Packing Density of fibers: | 0.5194 (51.94% of the |
| area of the header) | |
| Overall Module Dimensions: | 247 mm × 350 mm |
| | (Dia. × Length) |
| Membrane Module Housing Material: | Polysulfone |
| Streams Inlet and Exit Port | 40 mm |
| Dimensions: | |

*length includes ends of a fiber potted in opposed headers
^{▪}length of fiber between opposed faces of headers

The conditions of the gaseous streams entering and exiting the aforespecified module are presented in Table VI below. The more humid “stream 25” is introduced into the lumens (bores) of the fibers, and the less humid “stream 31” is introduced in the shell side of each module so as to flow around and in contact with the outside surfaces of the fibers.

TABLE VI

| | Conditions of Streams 25, 31, 36 and 35 | | | |
|---|---|---|---|---|
| | Str'm 25 | Str'm 31 | Str'm 36 | Str'm 35 |
| | Inlet | Inlet | Outlet | Outlet |
| Temperature, ° C. | 80 | 120 | 114.7 | 85.5 |
| Pressure kPa. abs. | 275.8 | 308.2 | 264.0 | 301.2 |
| (psia) | 40.0 | 44.7 | 38.3 | 43.7 |
| Water Activity: | 1.00 | 0.037 | 0.14 | 0.57 |
| Vapor mole fraction | 1.00 | 1.00 | 1.00 | 1.00 |
| Total molar flow | 11.12 | 10.52 | 10.08 | 11.56 |
| (kmol/hr) | | | | |
| Total mass flow (kg/hr) | 296.44 | 300.96 | 277.82 | 319.60 |
| Total volumetric flow* | 118.06 | 111.70 | 123.04 | 114.38 |
| (act. m³/hr) | | | | |
| Total volumetric flow ^{▪} | 249.02 | 235.92 | 225.78 | 259.18 |
| (std. m³/hr) | | | | |
| Mass % of H₂O | 11.61 | 1.48 | 5.63 | 7.27 |
| Mass % of O₂ | 11.61 | 22.87 | 12.44 | 21.50 |
| Mass % of N₂ | 76.78 | 75.64 | 81.93 | 71.23 |
| Mole % of H₂O | 17.20 | 2.36 | 8.62 | 11.16 |
| Mole % of O₂ | 9.68 | 20.44 | 10.72 | 18.57 |
| Mole % of N₂ | 73.12 | 77.21 | 80.66 | 70.27 |

*actual flow
^{▪}flow at standard temperature and pressure conditions

The performance of modules is characterized by the results in following Table VII.

TABLE VII
Results

| | |
|---|---|
| H₂O Recovery (%) | 54.55 |
| O₂ Leakage (%) | −0.2 |
| N₂ Leakage (%) | −0.007 |
| Stream 25 ΔP, kPa (psi) | 11.78 (1.71) |
| Stream 25 ΔP, % of inlet | 4.28 |
| Stream 31 ΔP, kPa (psi) | 7.01 (1.02) |
| Stream 31 ΔP, % of inlet | 2.28 |

The single module M3 contains 75,000 fibers each having the same specifications as those in M3A and M3B, except for the 535 mm (total) fiber length of each, providing an active fiber length of 428 mm, and cumulatively an active area of 50.5 m2. The fiber bundle dia. is 190 mm so that the ratio Ω is 2.816. The packing of the fibers in M3 is 0.5194 (51.94% of the area of the header). The overall module dimensions are 247 mm (OD) and 565 mm (length).

The benefit of splitting the required membrane surface area between two modules in parallel instead of having all the area in a single module M3 is evident in the following comparisons:

| | H₂O Recovery, % | O₂ Leakage, % | N₂ Leakage, % |
|---|---|---|---|
| M3 | 51.2 | −0.22 | −0.015 |
| (Single Module) | | | |
| M3A & M3B | 54.55 | −0.20 | −0.007 |
| (Twin Modules) | | | |

The following are the pressure drops for streams 25 and 31 entering M3 and M3A & M3B respectively.

| | Str'm 25 ΔP | Str'm 25 ΔP | Str'm 25 ΔP | Str'm 25 ΔP |
|---|---|---|---|---|
| | kPa (psi) | % of inlet | kPa (psi) | % of inlet |
| M3 | 41.83 (6.07) | 15.20 | 31.74 (4.60) | 9.50 |
| (Single | | | | |
| Module) | | | | |
| M3A & M3B | 11.70 (1.71) | 4.28 | 7.01 (1.02) | 2.28 |
| (Twin | | | | |
| Modules) | | | | |

### EXAMPLE 4

The following example illustrates water recovery from cathode exhaust of an air-cooled PEM fuel cell of 1 KW electrical output power capacity operating at 50° C. constructed from composite polyethersulfone (PES) hollow fiber membranes (asymmetric PES hollow fibers coated with dense skin of poly(dimethyl siloxane) (PDMS) to remove defects) (available from National University of Singapore, Singapore) is used for water exchange from a hot and saturated cathode exhaust gas (Stream 25) to a cooler and drier cathode inlet gas (Stream 31) at a pressure of 111.6 kPa.abs. (16.2 psia or 1.5 psig). In addition to water recovery of nearly 50%, the module also functions as an efficient heat exchanger to heat reactant air at 25° C. to near-operating temperature of the fuel cell.

The following example illustrates water recovery from cathode exhaust of an air-cooled PEM fuel cell of 1 kW electrical output power capacity operating at 5° C. and at a pressure near ambient pressure.

To show that acceptably high water recovery may be obtained even with a membrane having low water flux (175 GPU), a module The same assumptions made for calculations in Example 1 above are made here, except that pressure drop through the cathode side of the fuel cell is assumed to be 3.5 kPa (0.5 psi) approximately.

A membrane module designated M4 is constructed with the following specifications:

Membrane type: Composite (Asymmetric hollow-fiber membrane from glassy polymer coated with dense skin of rubbery polymer)

Water-uptake: <10 wt % at 30° C. at a water activity of 1.0.

H₂O flux at 50° C.: 175 GPU (based on OD of fiber)

O₂ flux at 50° C.: 8.8 GPU (based on OD of fiber) N₂ flux at 50° C.: 1.56 GPU (based on OD of fiber)

| | |
|---|---|
| H₂O/O₂ selectivity: | 20 |
| H₂O/N₂ selectivity: | 112 |
| Hollow fiber inside diam.: | 380 μm |
| Hollow fiber outside diam.: | 610 μm |
| Number of Fibers in module: | 75,000 |
| Total Fiber Length*, “L”: | 210 mm |
| Active Fiber Length^{▪}: | 107 mm |
| Active membrane area: | 15.38 m² (based on OD of fiber) |
| Fiber Bundle OD, “Φ”: | 190 mm |
| Ratio (L/Φ) = Ω | 1.105 |
| Shell inside diam.: | 200 mm |
| Packing Density of fibers: | 0.7729 (77.29% of the area of the |
| | header) |
| Membrane Module Overall | 247 mm × 240 mm (Dia. × Length) |
| Dimensions: | |
| Membrane Module Housing | Polysulfone |
| Material: | |
| Streams Inlet and Exit Port | 40 mm |
| Dimensions: | |

*length includes ends of a fiber potted in opposed headers
^{▪}length of fiber between opposed faces of headers

The conditions of the gaseous streams entering and exiting the aforespecified module are presented in Table VIII below. The more humid “stream 25” is introduced into the lumens (bores) of the fibers, and the less humid “stream 31” is introduced in the shell side so as to flow around and in contact with the outside surfaces of the fibers.

TABLE VIII

| | Conditions of Streams 25, 31, 36 & 35 | | | |
|---|---|---|---|---|
| | Str'm 25 | Str'm 31 | Str'm 36 | Str'm 35 |
| | Inlet | Inlet | Outlet | Outlet |
| Temperature, ° C. | 50 | 25 | 35.7 | 50 |
| Pressure kPa · abs. | 106.9 | 111.7 | 106.3 | 111.4 |
| (psia) | (15.5) | (16.2) | (15.47) | (16.10 |
| Water Activity: | 1.00 | 0.75 | >1.00 | 0.68 |
| Vapor mole fraction | 1.00 | 1.00 | 0.99 | 1.00 |
| Total molar flow | 0.234 | 0.228 | 0.222 | 0.240 |
| (kmol/hr) | | | | |
| Total mass flow (kg/hr) | 6.414 | 6.513 | 6.214 | 6.713 |
| Total volumetric flow | 5.88 | 5.05 | 5.32 | 5.78 |
| *(act. m³/hr) | | | | |
| Total volumetric flow^{▪} | 5.25 | 5.10 | 4.98 | 5.37 |
| (std. m³/hr) | | | | |
| Mass % of H₂O | 7.62 | 1.35 | 4.02 | 4.87 |
| Mass % of O₂ | 15.50 | 22.98 | 16.60 | 21.73 |
| Mass % of N₂ | 76.88 | 75.67 | 79.38 | 73.40 |
| Mole % of H₂O | 11.59 | 2.14 | 6.24 | 7.57 |
| Mole % of O₂ | 13.26 | 20.55 | 14.51 | 19.03 |
| Mole % of N₂ | 75.15 | 77.31 | 79.25 | 73.40 |

*actual flow
^{▪}flow at standard temperature and pressure conditions

The performance of the membrane and membrane module were characterized by the results in following Table IX, obtained by computing the same considerations calculated in prior Example 1.

TABLE IX
Results

| | |
|---|---|
| H₂O Recovery (%) | 48.9 |
| O₂ Leakage (%) | −2.52 |
| N₂ Leakage (%) | −0.029 |
| Stream 25 ΔP, kPa (psi) | 0.52 (0.075 psi) |
| Stream 25 ΔP, % of inlet | 0.49 |
| Stream 31 ΔP, kPa | 0.33 (0.048 psi) |
| Stream 31 ΔP, % of inlet | 0.30 |

The above data provide evidence that membranes having a water flux of 175 GPU yield acceptable water recovery in many applications. The module also simultaneously provides acceptable leakage and acceptable pressure drop of streams 25 and 31.

### EXAMPLE 5

The following example illustrates water recovery from the anode exhaust of the water-cooled PEM fuel cell operating with an electrical output of 75 kW, using an integrally skinned trilayer aromatic polyimide hollow fiber membrane (commercially available as Vapor Permeation Membrane from Ube Industries Ltd., Japan) in a module designated M5. Water is to be transferred from wet, substantially saturated (>90% relative humidity) anode exhaust stream 26, into hot and dry reformer inlet gas (natural gas, in this illustrative example) at 308 kpa.abs. (30 psig) from compressor after-cooler. After water from the anode's exhaust is recovered in the natural gas it is preferably sequentially flowed to a steam reformer and high temperature shift reactor before progressing to a low temperature shift reactor and then a methanation reactor to yield the desired hydrogen-rich gas stream 21 to the inlet of the anode of the PEM fuel cell. The flow rate of natural gas which is typically flowed through the shell-side of the module as the initial hot and dry stream 28, is much lower than the flow rate of the anode exhaust stream 26 which enters the lumen side of the module. If desired, the zones through which each stream traverses the module may be interchanged.

The same assumptions made in Example 3 above are made herein, except that: (i) pressure drop from the discharge port of the compressor, through the intercooler and related equipment, to the inlet of the anode side of the fuel cell is zero (excluding pressure drop through the module); (ii) the pressure drop through the anode side of the fuel cell ≈20.7 kPa (3.0 psi); (iii) the anode exhaust gas is substantially saturated; (iv) the fuel (natural gas) is 100% methane, and (v) hydrogen utilization is 80%.

The module M5 is constructed with the same fibers and has the same specifications M3A and M3B used in Example 3 above. The properties of the membranes under the conditions in M5 are as follows:

| | |
|---|---|
| H₂O flux at 80° C. & 150° C.: | 1200 GPU |
| | (based on fiber OD) |
| H₂ flux at 80° C. & 150° C.: | 46.4 & 140.8 GPU resply. |
| | (based on fiber OD) |
| CO flux at 80° C. & 150° C.: | 0.8 & 3.4 GPU resply. |
| | (based on fiber OD) |
| CO₂ flux at 80° C. & 150° C.: | 6.2 & 16.0 GPU resply. |
| | (based on fiber OD) |
| CH₄ flux at 80° C. & 150° C.: | 0.3 & 1.8 GPU resply. |
| | (based on fiber OD) |
| H₂O/H₂ selectivity @ 80° C. & 150° C.: | 26 and 8.5 resply. |
| H₂O/CO selectivity @ 80° C. & 150° C.: | 1500 and 353 resply. |
| H₂O/CO₂ selectivity @ 80° C. & 150° C.: | 193 and 75 resply. |
| H₂O/CH₄ selectivity @ 80° C. & 150° C.: | 4000 and 667 resply. |

The conditions of the gaseous streams entering and exiting the aforespecified module are presented in Table X below. The more humid “stream 26” from the anode exhaust is introduced into the lumens of the fibers, and the less humid natural gas “stream 28” is introduced in the shell side.

TABLE X

| | Conditions of Streams 26, 28, 27 and 29 | | | |
|---|---|---|---|---|
| | Str'm 26 | Str'm 28 | Str'm 27 | Str'm 29 |
| | Inlet | Inlet | Outlet | Outlet |
| Temperature, ° C. | 80 | 150 | 126.8 | 81.0 |
| Pressure kPa · abs. | 287.5 | 308.2 | 285.3 | 306.6 |
| (psia) | 41.67 | 44.67 | 41.35 | 44.44 |
| Water Activity: | 0.93 | 0.0 | 0.08 | 0.88 |
| Vapor mole fraction | 1.00 | 1.00 | 1.00 | 1.00 |
| Total molar flow | 1.58 | 0.79 | 1.30 | 1.08 |
| (kmol/hr) | | | | |
| Total mass flow (kg/hr) | 37.15 | 12.73 | 33.19 | 16.70 |
| Total volumetric flow* | 16.05 | 9.05 | 15.06 | 10.30 |
| (act. m³/hr) | | | | |
| Total volumetric flow^{▪} | 35.38 | 17.79 | 29.03 | 24.15 |
| (std. m³/hr) | | | | |
| Mass % of H₂O | 11.77 | 0.00 | 4.91 | 16.45 |
| Mass % of H₂ | 2.94 | 0.00 | 2.62 | 1.33 |
| CO, ppmw | 34.6 | 0.00 | 38.6 | 0.35 |
| Mass % of CO₂ | 80.26 | 0.00 | 86.74 | 6.15 |
| Mass % of CH₄ | 5.02 | 100.0 | 5.72 | 76.07 |
| Mole % of H₂O | 15.38 | 0.00 | 6.98 | 14.15 |
| Mole % of H₂ | 34.33 | 0.00 | 33.37 | 10.20 |
| CO, ppmv | 29.1 | 0.00 | 35.3 | 0.19 |
| Mole % of CO₂ | 42.91 | 0.00 | 50.51 | 2.16 |
| Mole % of CH₄ | 7.36 | 100.0 | 9.14 | 73.49 |

*actual flow
^{▪}flow at standard temperature and pressure conditions

The performance of the membrane and membrane module were characterized by the results in following Table XI, obtained by computing the following considerations listed below:

TABLE XI
Results

| | |
|---|---|
| H₂O Recovery (%) | 62.8 |
| Recovered Leakage (%) | 20.3 |
| CO Leakage (%) | 0.45 |
| CO₂ Leakage (%) | 3.4 |
| CH₄ Leakage, loss (%) | −0.26 |
| Stream 26 ΔP, kPa (psi) | 2.23 (0.32) |
| Stream 26 ΔP, % of inlet | 0.77 |
| Stream 28 ΔP, kPa (psi) | 1.57 (0.23) |
| Stream 28 ΔP, % of inlet | 0.51 |

As is evident from the above results, despite the relatively low selectivity of the membrane for water over hydrogen, the recovery of water is high; in fact, low selectivity is desirable in this case because approximately 20% of the hydrogen in the anode exhaust gas was recovered due to the high leakage.

The following illustrative comparison shows the criticality of selectivity on the practical performance of a membrane module for the water management system a module, designated M1, described in Example 1 above, relative to three comparative modules designated CM1, CM2 and CM3 in which membranes have lower selectivities than that of M1.

The comparative effect of selectivity, though given relatively low values herein, is demonstrated in calculations for the three comparative modules CM1, CM2 and CM3 which are fabricated with non-hydrophilic hollow fiber membranes having different selectivities for water relative to oxygen, and, to nitrogen (referred to as “112 O/O₂ and H₂O/N₂ selectivities”), but the same flux for water vapor (“H₂O flux”) and the same water uptake <10 wt %, as the polyimide membrane in M1; all other specifications of the hypothetical membranes of CM1, CM2 and CM3 are the same for each module. In the following Table XII, the value of flux is based on the outside diameter of a fiber.

Module Specifications: Each fiber in modules CM1, CM2 and CM3 is formed from a polymeric material having a water uptake of <10 wt % at at water activity of 1.0 at a temperature of 30° C.; and the inside diameter (ID) and outside diameter (OD) of each fiber is 350 μm and 490 μm respectively.

TABLE XII

| | CM1 | CM2 | CM3 | Ex. 1 (M1) |
|---|---|---|---|---|
| H₂O flux at 70° C. | 1500 GPU | 1500 GPU | 1500 GPU | 1500 GPU |
| O₂ flux at 70° C. | 429 GPU | 188 GPU | 75 GPU | 15.6 GPU |
| N₂ flux at 70° C. | 375 GPU | 125 GPU | 42 GPU | 2.7 GPU |
| H₂O/O₂ selectivity | 3.5 | 8 | 20 | 96 |
| H₂O/N₂ selectivity | 4 | 12 | 36 | 556 |

The remaining following specifications of each of the comparative modules, namely, inside and outside diameters of the hollow fibers; number of fibers; total fiber length; active fiber length; active membrane area; fiber bundle diameter; shell inside dia.; packing density; overall module dimensions; material of module housing; dimensions of ports of inlet and exit streams; are the same as those listed hereinabove for M1.

The performance of the membrane modules in the following Table XIII shows results indicating the criticality of selectivity of membranes used in the construction of a module for a practical water and energy management system, with respect to key considerations, namely: (a) the amount of water transferred, or water recovered (%); (b) leakage of unwanted components (O₂ and N₂ in this example); and (c) pressure drop of a wet or humid first stream on one side of the membrane (in the lumens in this example), and pressure drop of a second stream on the other side of the membrane (the shell side in this example).

In this comparison, the pressure drop through the lumen and shell side of each module CM1, CM2 and CM3 is substantially the same as that for M1 due to their identical construction. The values of leakage of oxygen and nitrogen are denoted by negative values to indicate that the direction of transfer is from the oxidant stream into the exhaust stream.

TABLE XIII
Results

| | CM1 | CM2 | CM3 | Mod. 1 |
|---|---|---|---|---|
| H₂O recovery, % | 49.5 | 50.8 | 51.3 | 51.6 |
| O₂ leakage, % | −14.8 | −7.2 | −3.07 | −0.64 |
| N₂ leakage, % | −5.4 | −1.7 | −0.55 | −0.03 |

As is evident from the above, lower selectivity will increase oxygen leakage, thereby, decreasing the partial pressure of oxygen in the cathode reactant stream which will lead to decrease in output power of the fuel cell system. Furthermore, the parasitic power loss will go up because the cathode reactant flow rate will have to be increased to compensate for the oxygen lost by leakage.

Therefore, the higher the selectivity, the better, because leakage is minimized. However, other factors such as water uptake and water flux are also important criteria for selecting suitable membranes. Therefore, there is always an optimum when several factors must be balanced. In particular, though there is no established criterion for allowable oxygen loss, in a typical fuel cell such as described herein, it is essential that the membrane have a water/oxygen selectivity and water/nitrogen selectivity preferably in the range from 20-1000.

The following illustrative comparison shows the effect of varying values of the water flux on the recovery of water in four comparative modules designated CM4, CM5, CM6 and CM7 for each of which the selectivities are the same as that for M1 described in Example 1 above. For each of the five modules, the H₂O/O₂ selectivity is 96; and the H₂O/N₂ selectivity is 556. As before, the streams 25 and 31 are introduced in the lumen and shell side respectively, and the inlet pressure of each stream is as stated earlier. The pressure drops through the wet zone and the dry zone are essentially the same as before.

Module Specifications: Fibers in each module CM4, CM5, CM6 and CM7 are formed of a polymeric material having a water uptake of <10 wt % at a water activity of 1.0 at a temperature of 30° C.; and the inside diameter (ID) and outside diameter (OD) of each fiber is 350 μm (microns) and 490 μm respectively. Except for the membrane material, the specifications for each of the four comparative modules are the same as those for M1 used in Example 1.

TABLE XIV

| | CM4 | CM5 | CM6 | CM7 | M1 |
|---|---|---|---|---|---|
| H₂O flux @ 70° C., GPU | 50 | 200 | 375 | 750 | 1500 |
| O₂ flux @ 70° C., GPU | 0.52 | 2.08 | 3.9 | 7.8 | 15.6 |
| N₂ flux @ 70° C., GPU | 0.09 | 0.36 | 0.68 | 1.35 | 2.7 |

TABLE XV
Results

| | CM4 | CM5 | CM6 | CM7 | M1 |
|---|---|---|---|---|---|
| H₂O recovery, % | 3.7 | 13.1 | 21.9 | 35.5 | 51.5 |
| O₂ leakage, % | −0.029 | −0.11 | −0.2 | −0.37 | −0.64 |
| N₂ leakage, % | −0.003 | −0.009 | −0.015 | −0.024 | −0.035 |

It is evident from the data in Table XV above that, despite the selectivities being the same, the recovery of water (%) drops off to unacceptably low level at a water flux of 50 GPU.

The following illustrative comparison shows the effect of critically of appropriate design of membrane module (specifically L/φ) ratio, Ω) on pressure drop of streams 25 and 31 of Example 3 when run in parallel through two modules with different Ω ratios from M3A & M3B used in Example 3. In this comparison, the same assumptions are made as those made in Example 3. To demonstrate the effect of Q on the efficiency of the water and energy management system, comparative modules CM8A & CM8B and CM9A & CM9B are made from the membrane used in M3A & M3B, therefore, water flux and water/gas selectivities for these six modules are the same. Additionally, each module has active area of 25.2 m², but unlike M3A & M3B (used in Example 3 for high efficiency), the diameters of the fiber bundles (Φ) in CM8A & CM8B and CM9A & CM9B are 90 mm and 140 mm respectively and the total fiber length (L) in CM8A & CM8B and CM9A & CM9B are 1170 mm and 558 mm respectively. Therefore, the L/Φ ratio, Ω is different for each pair of modules. All modules were constructed with polysulfone housing and 40 mm stream inlet and outlet ports.

The following Table XVI provides the comparison.

TABLE XVI

| | CM8A & B | | CM9A & B | | M3A & B | |
|---|---|---|---|---|---|---|
| No. of fibers | 15,000 | | 35,000 | | 75,000 | |
| Total fiber length, “L” | 1170 | mm | 558 | mm | 320 | mm |
| Active Fiber Length | 1070 | mm | 458 | mm | 214 | mm |
| OD of Fiber Bundle, | 90 | mm | 140 | mm | 190 | mm |
| Φ | | | | | | |
| L/Φ Ratio (Ω) | 13.0 | | 3.99 | | 1.68 | |
| Shell Inside Dia. | 98 | mm | 158 | mm | 200 | mm |
| Packing density, % | 46.3 | | 44.6 | | 51.9 | |

| | | | |
|---|---|---|---|
| Overall Mod. Dim. | 136 × 1215 | 210 × 588 | 247 × 350 |
| (Dia. × Length), mm | | | |

The importance of Ω on pressure drop as it affects performance of the modules is demonstrated in the following Table XVII which, in addition to (a) pressure drops experienced by each stream, shows results for (b) % water transferred, and (c) % leakage of other components.

In this comparison as before, the more humid stream is introduced through the lumens and the less humid stream through the shell side. As before, the values of leakage of oxygen and nitrogen are denoted by negative values to indicate that the direction of transfer is from the oxidant stream into the exhaust stream.

TABLE XVII
Results

| | CM8A & B | CM9A & B | M3A & B |
|---|---|---|---|
| H₂O recovery, % | 49.74 | 54.52 | 54.55 |
| O₂ leakage, % | −0.35 | −0.22 | −0.2 |
| N₂ leakage, % | −0.03 | −0.01 | −0.007 |
| Str'm 25 ΔP, kPa | 161.35 | 40.55 | 11.78 |
| (psi) | (23.4) | (5.9) | (1.7) |
| Str'm 25 ΔP, % | 37.17 | 13.03 | 4.28 |
| Str'm 31 ΔP, kPa | 91.08 | 7.71 | 7.01 |
| (psi) | (13.2) | (1.1) | (1.02) |
| Str'm 31 ΔP, % | 16.51 | 2.25 | 2.28 |
| Compressor kW | 13.14 | 8.81 | 7.9 |
| Additional kW^{♦} | 5.24 | 0.91 | |

^{♦}consumption relative to M3A & B in Example 3.

As is evident from the above, the pressure drop of 37.2% in the lumen side of the small diameter modules CM8A & B (a size used in conventional drying applications), is unacceptably high causing large parasitic losses thus reducing the power output of the fuel cell. With a pressure drop of >15%, the parasitic losses would be unacceptable in most fuel cells.

Having thus provided a general discussion, described the overall process in detail and illustrated the invention with specific examples of the best modes of carrying out the process, it will be evident that the invention has provided an effective solution to a difficult problem. It is therefore to be understood that no undue restrictions are to be imposed by reason of the specific embodiments illustrated and discussed, and particularly, that the invention is not restricted to a slavish adherence to the details set forth herein.

I claim:

1. In a method for transport of water in a fuel cell system from a first predominantly gaseous stream having a higher partial-pressure of water to a second predominantly gaseous stream having a lower partial pressure of water, by mass and heat transfer through a plurality of membranes in a membrane module, the first and second gaseous streams flowing through first and second zones respectively separated by the membranes in the module, the improvement comprising,
transporting water from the first gaseous stream into the second gaseous stream through a non-hydrophilic membrane having a selective layer with an average pore size smaller than 100 Å, and the membrane having a water uptake of less than 10% by weight measured at a water activity of 1.0 at 30° C., at a minimum pure component pressure-normalized water flux of 100 GPU at 50° C.;
maintaining an ideal selectivity of water over any other component in either stream greater than 5 at 50° C. while maintaining a higher partial pressure of water in the first gaseous stream than in the second gaseous stream; and,
maintaining a pressure drop through a selected zone of less than 15% of the absolute pressure at the entrance of the zone selected.

2. The method of claim 1 wherein the fuel cell system operates in the pressure range from about 1 atm to 10 atm and the non-hydrophilic membrane is selected from the group consisting of a hollow fiber membrane, a tubular membrane and a flat-sheet membrane.

3. The method of claim 2 wherein the non-hydrophilic membrane is selected from the group consisting of a glassy polymer and a rubbery polymer.

4. The method of claim 3 wherein the non-hydrophilic membrane includes a selective layer from the group consisting of an ultra-microporous having an average pore size in the range from 10 Å to 100 Å, and a dense membrane having an average pore size less than 10 Å.

5. The method of claim 4 wherein the non-hydrophilic membrane is selected from an isotropic membrane and an anisotropic membrane.

6. The method of claim 5 wherein the membrane is formed from a rubbery polymer selected from the group consisting of natural and synthetic polyisoprene, nitrile rubber, polybutadiene, polystyrene-butadiene copolymers, polyisobutyl-ene-isoprene copolymers, polyethylene-propylene copolymer, polychloroprene, chlorosulfonated polyethylene, thermoplastic elastomer, polyurethane, polyfluoro-carbon, polyfluorosilicone, and polysiloxane.

7. The method of claim 5 wherein the membrane is formed from a glassy polymer having a glass transition temperature Tg in the range from 90° C. to 350° C. and is selected from the group consisting of polycarbonate, polyetherimide, polysulfone, polyethersulfone, polyimide, polyamideimide, polyamide, poly(phenylene oxide), and polyacetylene.

8. The method of claim 5 wherein the non-hydrophilic membrane has a surface area in the range from 0.01 to 500 m².

9. The method of claim 8 wherein the non-hydrophilic membrane is a polymer selected from the group consisting of aromatic polyimide, polyaramid, aromatic polycarbonate, aromatic polyetherimide, and aromatic polyamideimide.

10. The method of claim 9 wherein the non-hydrophilic membrane is an anisotropic membrane.

11. The method of claim 8 wherein the non-hydrophilic membrane is a polydimethylsiloxane.

12. The method of claim 8 wherein the ratio of the total length of the fiber and the diameter of the fiber bundle, Ω=L/□, is less than 5.

13. In a method for concurrently heating and humidifying an oxidant stream to a proton exchange membrane “PEM” fuel cell by direct heat and mass transfer from an exhaust stream from the fuel cell's cathode, the improvement comprising, flowing the exhaust stream, substantially saturated with water through a relatively low-pressure zone in a first side of a membrane module;
using a non-hydrophilic membrane having a water-uptake of less than 10% by weight, measured at a water activity of 1.0 at 30° C., at a minimum pure component pressure-normalized water permeation flux of 100 GPU at 50° C.;
flowing the oxidant stream through a relatively higher-pressure zone in the membrane module, the low-pressure zone and the high-pressure zone being separated by the membrane; and,
maintaining an ideal water/oxygen selectivity of at least 5 at operating temperature in the range from about 50° C. to 250° C.; and,
maintaining a pressure drop through the low-pressure zone of less than 15% of the absolute pressure at the entrance of the low-pressure zone.

14. In a method for concurrently heating and humidifying a anode side reactant (fuel) gas stream to a proton exchange membrane “PEM” fuel cell by direct heat and mass transfer from an exhaust stream from the fuel cell's anode, the improvement comprising,
flowing the exhaust stream, substantially saturated with water, through a relatively low-pressure zone in a first side of a membrane module;
using non-hydrophilic membrane having a water-uptake of less than 10% by weight, measured at a water activity of 1.0 at 30° C., at a minimum pure component pressure-normalized water permeation flux of 100 GPU at 50° C.;
flowing the anode side reactant gas stream through a relatively higher-pressure zone in the membrane module, the low-pressure zone and the high-pressure zone being separated by the membrane; and,
maintaining an ideal water/hydrogen selectivity of at least 5 at operating temperature in the range from about 50° C. to 250° C.; and,
maintaining a pressure drop through the low-pressure zone of less than 15% of the absolute pressure at the entrance of the low-pressure zone.
